(19) United States
(12) Patent Application Publication
(10) Pub. No.: US 2016/0271883 A1
(43) Pub. Date: Sep. 22, 2016

(54) DEVICE AND METHOD FOR VERIFYING SUPPORT OF 3D PRINTING

(71) Applicant: ELECTRONICS AND TELECOMMUNICATIONS RESEARCH INSTITUTE, Daejeon (KR)

(72) Inventors: Soon-Young KWON, Daejeon (KR); Jin-Seo KIM, Deajeon (KR); Yoon-Seok CHOI, Daejeon (KR); In-Su JANG, Daejeon (KR)

(21) Appl. No.: 14/835,428

(22) Filed: Aug. 25, 2015

(30) Foreign Application Priority Data
Mar. 17, 2015 (KR) 10-2015-0036978

(51) Int. Cl. B29C 67/00; G05B 19/4099

(52) U.S. Cl. CPC B29C 67/0088; G05B 19/4099; B33Y 50/02

(57) ABSTRACT

The present disclosure relates to a device and a method for verifying support of 3D printing and more particularly, to a device and a method for verifying whether a support is formed properly for printing through a 3D printer.

### CROSS REFERENCE TO RELATED APPLICATION

This application claims the benefit of Korean Patent Application No. 10-2015-0036978, filed on Mar. 17, 2015, entitled “Device and method for verifying support of 3D printing”, which is hereby incorporated by reference in its entirety into this application.

### TECHNICAL FIELD

Exemplary embodiments of the present disclosure relate to a device and a method for verifying support of 3D printing, and more particularly to a technology for verifying whether particular requirements are satisfied or not when a support is generated for 3D printing.

### BACKGROUND

A 3D printing technology has recently emerged as a promising technology by various institutions. A 3D printer is a device to make a three-dimensional object by laying down materials such as polymer, metal and the like in a liquid or powder form in layers based on design data. It is expected to be developed to changes in consumption patterns, promotions in staring businesses, creations of new products and services and increases in productivities with economic effects of the 3D printing technology.

Since the 3D printer outputs a 3D object in layer-by-layer, a support is needed to hold the 3D object. Here, the support is needed to be outputted optimally.

Technical background of the present disclosure is described in KR Patent Publication No 2008-0082909 (published in Sep. 12, 2008, 3D printer).

### SUMMARY

Accordingly, an object of the present disclosure is to provide a device and a method for verifying support of 3D printing which is able to not only reduce probability of failure to get the results users need from 3D printing but also reduce time and cost by reducing amount of supports.

It is to be appreciated that objects of the present disclosure are not limited by the object described above and other objects will become more apparent by describing in detail exemplary embodiments thereof below.

According to an aspect of the present disclosure, there is provided a device for verifying support of 3D printing.

A device for verifying support of 3D printing according to an embodiment of the present disclosure may include: a 3D model output data input unit configured to input 3D output data of an object to be outputted through a 3D printer; a support verifying unit configured to verify whether a support supports a printout using the 3D output data and feature data of the 3D printer to generate verification result information; and an output controlling unit configured to control output of the 3D printer based on the verification result information.

According to another aspect of the present disclosure, there is provided a method for verifying support of 3D printing.

A method for verifying support of 3D printing according to an embodiment of the present disclosure may include: inputting 3D output data of an object to be printed through a 3D printer; generating verification result information by verifying whether a support supports a printout using the 3D output data and feature data of the 3D printer; and controlling output of the 3D printer based on the verification result information.

The present disclosure allows quality results users need from a 3D printer by outputting optimal supports through the device and the method for verifying support of 3D printing.

The present disclosure also allows to save time and cost associated with 3D printing by reducing probability of failure.

### BRIEF DESCRIPTION OF DRAWINGS

FIG. 1 is a diagram to explain a system for verifying support of 3D printing according to an embodiment of the present disclosure.

FIG. 2 to FIG. 5 are diagrams to explain a device for verifying support of 3D printing according to an embodiment of the present disclosure.

FIG. 6 is a flowchart illustrating a method for verifying support of 3D printing according to an embodiment of the present disclosure.

### DETAILED DESCRIPTION

The present disclosure will be described with reference to particular embodiments along with the accompanying drawings. However, it is to be appreciated that various changes and modifications may be made. The exemplary embodiments disclosed in the present disclosure do not limit but describe the spirit of the present disclosure, and the scope of the present disclosure is not limited by the exemplary embodiments.

Unless clearly used otherwise, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain embodiments of the present disclosure will be described with reference to the accompanying drawings.

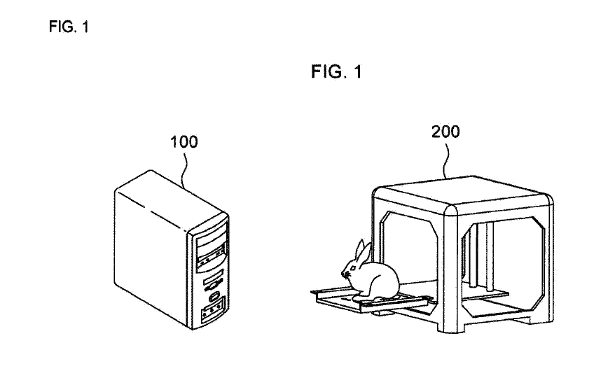

FIG. 1 is a diagram to explain a system for verifying support of 3D printing according to an embodiment of the present disclosure.

Referring to FIG. 1, a system for verifying support of 3D printing may include a device for verifying support of 3D printing 100 and a 3D printer 200.

The device for verifying support of 3D printing 100 may verify whether a support supports a printout property or not by using 3D output data and feature data of a 3D printer.

The device for verifying support of 3D printing 100 may determine whether there is any discontinuity point in a slicing process which outputs in layer-by-layer and, when it is determined as that there is a discontinuity point, verify whether the support supporting the discontinuity point is outputted or not.

The device for verifying support of 3D printing 100 may verify whether support formation information is appropriate or not depending on a printout using the feature data of the 3D printer. Here, the feature data of the 3D printer may include at least one of outputting method data of the 3D printer, material data of the 3D printer, and device feature data of the 3D printer. The support formation information may include at least one of spacing information of the support, information of number of supports, thickness information of the support, and supporting angle information of the support.

The device for verifying support of 3D printing 100 may extract inflection points of a printout of the 3D printer and, when a downward inflection point exists among the inflection points, verify whether the support supporting the downward inflection point is outputted or not.

The device for verifying support of 3D printing 100 may verify whether the support supports a printout property and control output of the 3D printer 200 based on the verification result information.

The 3D printer 200 may transmit the feature data of the 3D printer to the device for verifying support of 3D printing 100 which thus further outputs based on the support verification result information.

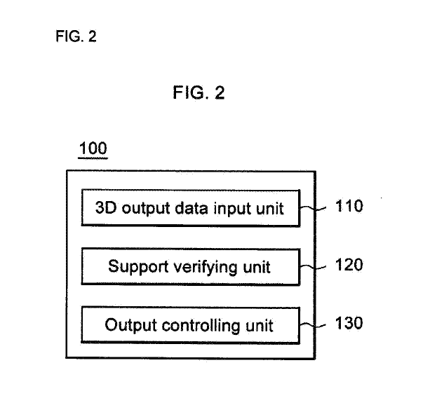

FIG. 2 to FIG. 5 are diagrams to explain a device for verifying support of 3D printing according to an embodiment of the present disclosure.

Referring to FIG. 2, the device for verifying support of 3D printing 100 may include a 3D output data input unit 110, a support verifying unit 120 and an output controlling unit 130.

The 3D output data input unit 110 may input 3D output data of an object to be outputted through the 3D printer. Here, the 3D output data may be 3D model texture data information including color information.

The support verifying unit 120 may generate verification result information by verifying whether a support supports a printout property using the 3D output data and feature data of the 3D printer.

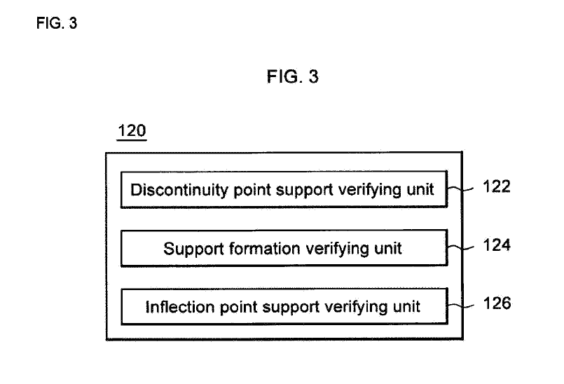

Referring to FIG. 3, the support verifying unit 120 may include a discontinuity point support verifying unit 122, a support formation verifying unit 124 and an inflection point support verifying unit 126.

The discontinuity point support verifying unit 122 may determine whether there is any discontinuity point in a slicing process which outputs in layer-by-layer and, when it is determined as that there is a discontinuity point, verify whether the support supporting the discontinuity point is outputted or not.

Since the 3D printer 200 uses a layer-by-layer method, it performs a slicing process for a 3D model into a 2D image in order to print. The discontinuity point support verifying unit 122 may compare the n^{th} slice with the n−1^{th} slice, except the 1^{st} slice, to verify the n^{th} slice. That is, the discontinuity point support verifying unit 122 may determine whether a slice overlaps with its previous slice when it is outputted. When it is determined as that a slice overlaps with its previous one, the discontinuity point support verifying unit 122 may determine that 3D printout is continuously outputted since there are continuity points. On the other hand, when it is determined as that a slice does not overlap with its previous one at all, it may determine that they are discontinuity points and a support is needed. This is why even though discontinuity points are outputted, the printout therefrom is floated in the air and finally collapsed. The parts which are connected with the discontinuity points may be also collapsed which eventually causes failure of output.

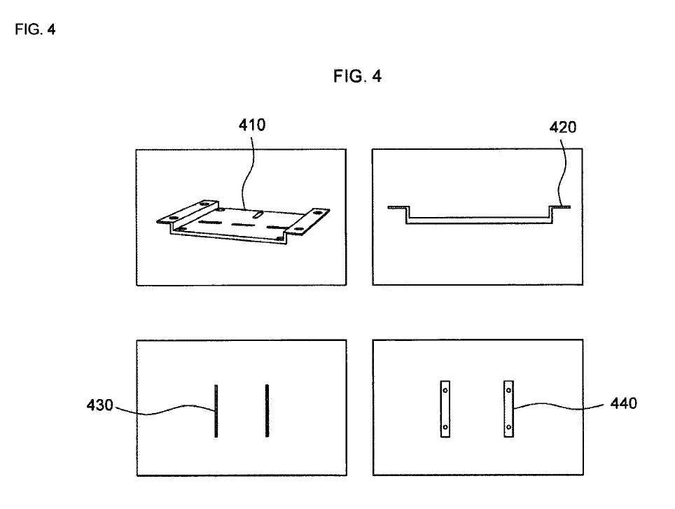

Referring to FIG. 4, the 3D printer 200 of the present disclosure may output a 3D model 410 by laying down successive layers from the bottom. Here, when a part 420 of the 3D model is outputted without a support, the part may be collapsed and it may finally cause failure of printing. In a sliced image of the 3D model 410, the image of the n^{th} slice may be 430 in FIG. 4 and the image of the N+1^{th} slice may be 440 in FIG. 4. The discontinuity point support verifying unit 122 may verify that a support is needed to the part which is not shown in the n^{th} slice 430 but shown in the N+1^{th} slice 440 and verify whether there is the support there.

The support formation verifying unit 124 may verify whether support formation information is appropriate or not depending on a printout using the feature data of the 3D printer 200. The 3D printer 200 of the present disclosure may output a support to hold the printout therefrom when the bottom surface of the printout is not a flat surface. Here, the force of the support may be determined depending on at least one of an outputting method, hardness of outputting materials, and a contact angle between a support and a printout. For example, in a fused disposition modeling (FDM) method which works by laying down materials in layers, support spacing may be set every layer, and in a digital light processing (DLP) method which works by microscopically laying down small mirrors, support spacing may be relatively wide to hold a printout. In addition, when a material for 3D printing is a hard material, the support spacing is wide to hold a printout. Support spacing may be determined by controlling a contact angle between a support and a printout. For example, when a contact angle between a support and a printout is 90 degree, the support can support a relatively large amount if horizontal. Accordingly, the support may be determined based on feature data of the 3D printer in addition to 3 parameters of an outputting method, hardness of outputting materials, and a contact angle between a support and a printout.

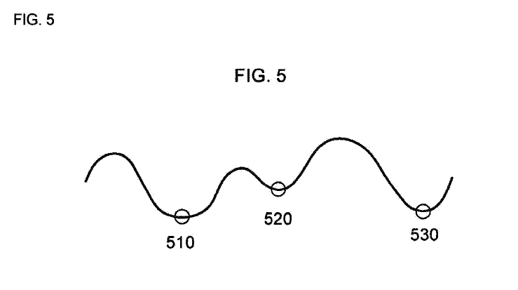

The inflection point support verifying unit 126 may extract inflection points of a printout and, when a downward inflection point exists among the inflection points, verify whether the support supporting the downward inflection point is outputted or not. Referring to FIG. 5, the inflection point support verifying unit 126 may detect the lowest points 510, 520 and 530 in a curved 3D model to verify whether supports are formed or not. When there is no support at the lowest point of the downward inflection point, the corresponding printout may be collapsed.

The output controlling unit 130 may determine whether further support formation is needed for printing through the 3D printer based on the verification result information. When it is determined as that further support formation is needed, the output controlling unit 130 may control the 3D printer 200 for the support formation.

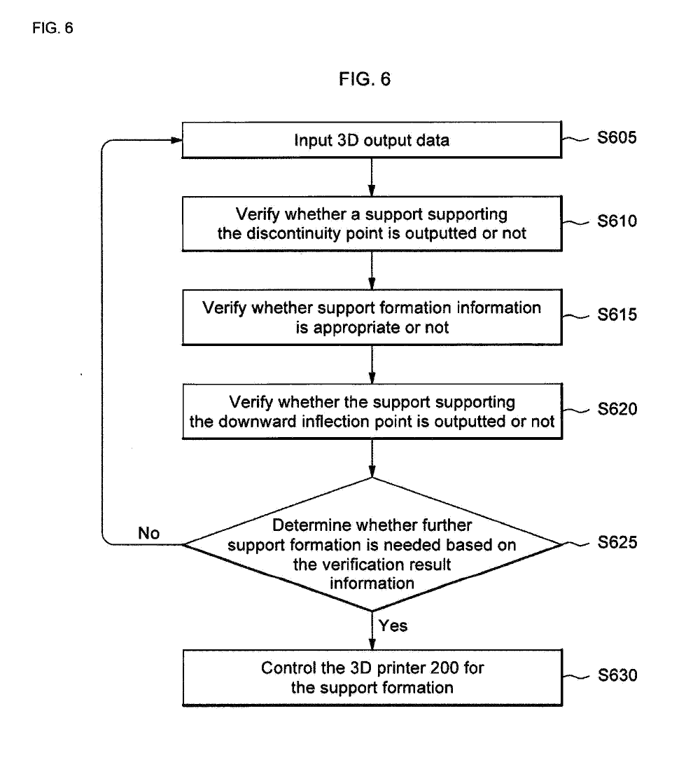

FIG. 6 is a flowchart illustrating a method for verifying support of 3D printing according to an embodiment of the present disclosure.

Referring to FIG. 6, in S605, the device for verifying support of 3D printing 100 may input 3D output data of an object to be outputted through the 3D printer 200.

In S610, the device for verifying support of 3D printing 100 may determine whether there is any discontinuity point in a slicing process and, when it is determined as that there is a discontinuity point, verify whether a support supporting the discontinuity point is outputted or not.

In S615, the device for verifying support of 3D printing 100 may receive feature data of the 3D printer 200 and verify whether support formation information is appropriate or not depending on a printout using the feature data of the 3D printer 200. Here, the feature data of the 3D printer may include at least one of outputting method data of the 3D printer, material data of the 3D printer, and device feature data of the 3D printer. The support formation information may include at least one of spacing information of the support, information of number of supports, thickness information of the support, and supporting angle information of the support.

In S620, the device for verifying support of 3D printing 100 may extract inflection points of a printout and, when a downward inflection point exists among the inflection points, verify whether the support supporting the downward inflection point is outputted or not.

In 8625, the device for verifying support of 3D printing 100 may determine whether further support formation is needed for printing through the 3D printer based on the verification result information.

In S630, when it is determined as that further support formation is needed, the device for verifying support of 3D printing 100 may control the 3D printer 200 for the support formation.

The method for verifying support of 3D printing according to an exemplary embodiment of the present disclosure can be implemented by the method which the computer is implemented or in non-volatile computer recording media stored in computer executable instructions. The computer readable medium may include a program instruction, a data file and a data structure or a combination of one or more of these.

The program instruction recorded in the computer readable medium may be specially designed for the present disclosure or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present disclosure should be interpreted by the following claims and it should be interpreted that all spirits equivalent to the following claims fall with the scope of the present disclosure.

### DESCRIPTION OF REFERENCE NUMERALS

100: device for verifying support of 3D printing
200: 3D printer

1. A device for verifying support of 3D printing, comprising:
a 3D model output data input unit configured to input 3D output data of an object to be printed through a 3D printer;
a support verifying unit configured to verify whether a support supports a printout using the 3D output data and feature data of the 3D printer to generate verification result information; and
an output controlling unit configured to control output of the 3D printer based on the verification result information.

2. The device of claim 1, wherein the support verifying unit comprises a discontinuity point support verifying unit configured to determine whether there is any discontinuity point in a slicing process which outputs in layer-by-layer and, when it is determined as that there is a discontinuity point, verify whether the support supporting the discontinuity point is outputted or not.

3. The device of claim 1, wherein the support verifying unit comprises a support formation verifying unit configured to verify whether support formation information is appropriate or not depending on a printout using the feature data of the 3D printer, wherein the feature data of the 3D printer comprises at least one of outputting method data of the 3D printer, material data of the 3D printer, and device feature data of the 3D printer; and
the support formation information comprises at least one of spacing information of the support, information of number of supports, thickness information of the support, and supporting angle information of the support.

4. The device of claim 1, wherein the support verifying unit comprises an inflection point support verifying unit configured to extract inflection points of a printout of the 3D printer and, when a downward inflection point exists among the inflection points, verify whether the support supporting the downward inflection point is outputted or not.

5. The device of claim 1, wherein the output controlling unit determines whether further support formation is needed for printing through the 3D printer based on the verification result information and, when it is determined as that further support formation is needed, controls the 3D printer for the support formation.

6. A method for verifying support of 3D printing, comprising:
inputting 3D output data of an object to be printed through a 3D printer,
generating verification result information by verifying whether a support supports a printout using the 3D output data and feature data of the 3D printer; and
controlling output of the 3D printer based on the verification result information.

7. The method of claim 6, wherein the step for generating verification result information by verifying whether a support supports a printout comprises:
determining whether there is any discontinuity point in a slicing process which outputs in layer-by-layer; and
when it is determined as that there is a discontinuity point, verifying whether the support supporting the discontinuity point is outputted or not.

8. The method of claim 6, wherein the step for generating verification result information by verifying whether a support supports a printout comprises:
receiving feature data of the 3D printer; and
verifying whether support formation information is appropriate or not depending on a printout using the feature data of the 3D printer,
wherein the feature data of the 3D printer comprises at least one of outputting method data of the 3D printer, material data of the 3D printer, and device feature data of the 3D printer, and
the support formation information comprises at least one of spacing information of the support, information of number of supports, thickness information of the support, and supporting angle information of the support.

9. The method of claim 6, wherein the step for generating verification result information by verifying whether a support supports a printout comprises:
extracting inflection points of a printout of the 3D printer; and
when a downward inflection point exists among the inflection points, verifying whether the support supporting the downward inflection point is outputted or not.

10. The method of claim 6, wherein the step for controlling output of the 3D printer based on the verification result information comprises:
determining whether further support formation is needed for printing through the 3D printer based on the verification result information; and
when it is determined as that further support formation is needed, controlling the 3D printer for the support formation.

11. The device of claim 2,
wherein the support verifying unit comprises a support formation verifying unit configured to verify whether support formation information is appropriate or not depending on a printout using the feature data of the 3D printer, wherein the feature data of the 3D printer comprises at least one of outputting method data of the 3D printer, material data of the 3D printer, and device feature data of the 3D printer; and
wherein the support formation information comprises at least one of spacing information of the support, information of number of supports, thickness information of the support, and supporting angle information of the support.

12. The device of claim 2, wherein the support verifying unit comprises an inflection point support verifying unit configured to extract inflection points of a printout of the 3D printer and, when a downward inflection point exists among the inflection points, verify whether the support supporting the downward inflection point is outputted or not.
